(19) United States
(12) Patent Application Publication
(10) Pub. No.: US 2024/0056990 A1
(43) Pub. Date: Feb. 15, 2024

(54) ASSIGNING POWER CONTROL PARAMETERS FOR MULTIPLE TRANSMISSION RECEPTION POINT OPERATION

(71) Applicant: Nokia Technologies Oy, Espoo (FI)

(72) Inventors: Matha DEGHEL, Massy (FR); Keeth Saliya JAYASINGHE LADDU, Espoo (FI); Youngsoo YUK, Seoul (KR)

(21) Appl. No.: 18/260,484

(22) PCT Filed: Jan. 11, 2021
(86) PCT No.: PCT/EP2021/050342

§ 371 Date: Jul. 6, 2023

(51) Int. Cl. H04W 52/38; H04W 72/21

(52) U.S. Cl. CPC H04W 52/38; H04W 72/21

(57) ABSTRACT

Disclosed is a method comprising receiving a configuration from a base station, wherein the configuration comprises at least a first subset of power control parameters and a second subset of power control parameters. The first subset of power control parameters and the second subset of power control parameters are assigned to a physical uplink control channel resource. Uplink control information is transmitted or repeated at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

### FIELD

The following exemplary embodiments relate to wireless communication.

### BACKGROUND

As resources are limited, it is desirable to optimize the usage of network resources. Uplink power control may be used to control the transmit power of terminal devices in a cellular communication network in order to enable better usage of resources and enhanced user experience to the users of the terminal devices.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive a configuration from a base station, wherein the configuration comprises at least a first subset of power control parameters and a second subset of power control parameters; assign the first subset of power control parameters and the second subset of power control parameters to a physical uplink control channel resource; and transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided an apparatus comprising means for: receiving a configuration from a base station, wherein the configuration comprises at least a first subset of power control parameters and a second subset of power control parameters; assigning the first subset of power control parameters and the second subset of power control parameters to a physical uplink control channel resource; and transmitting or repeating uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided a method comprising receiving a configuration from a base station, wherein the configuration comprises at least a first subset of power control parameters and a second subset of power control parameters; assigning the first subset of power control parameters and the second subset of power control parameters to a physical uplink control channel resource; and transmitting or repeating uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided a computer program comprising instructions for causing an apparatus to perform at least the following: receive a configuration from a base station, wherein the configuration comprises at least a first subset of power control parameters and a second subset of power control parameters; assign the first subset of power control parameters and the second subset of power control parameters to a physical uplink control channel resource; and transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided a computer readable medium comprising program instructions for causing an apparatus to perform at least the following: receive a configuration from a base station, wherein the configuration comprises at least a first subset of power control parameters and a second subset of power control parameters; assign the first subset of power control parameters and the second subset of power control parameters to a physical uplink control channel resource; and transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided a non-transitory computer readable medium comprising program instructions for causing an apparatus to perform at least the following: receive a configuration from a base station, wherein the configuration comprises at least a first subset of power control parameters and a second subset of power control parameters; assign the first subset of power control parameters and the second subset of power control parameters to a physical uplink control channel resource; and transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided an apparatus comprising at least one processor, and at least one memory including computer program code, wherein the at least one memory and the computer program code are configured, with the at least one processor, to cause the apparatus to: transmit a configuration to a terminal device, wherein the configuration comprises at least a first subset of power control parameters and a second subset of power control parameters; and transmit, to the terminal device, a first indication for using a physical uplink control channel resource associated with the first subset of power control parameters and the second subset of power control parameters.

According to another aspect, there is provided an apparatus comprising means for: transmitting a configuration to a terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters.

According to another aspect, there is provided a method comprising transmitting a configuration to a terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters.

According to another aspect, there is provided a computer program comprising instructions for causing an apparatus to perform at least the following: transmitting a configuration to a terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters.

According to another aspect, there is provided a computer readable medium comprising program instructions for causing an apparatus to perform at least the following: transmitting a configuration to a terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters.

According to another aspect, there is provided a non-transitory computer readable medium comprising program instructions for causing an apparatus to perform at least the following: transmitting a configuration to a terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters.

According to another aspect, there is provided a system comprising at least a base station and a terminal device. The base station is configured to: transmit a configuration to the terminal device, wherein the configuration comprises at least a first subset of power control parameters and a second subset of power control parameters; and transmit, to the terminal device, a first indication for using a physical uplink control channel resource associated with the first subset of power control parameters and the second subset of power control parameters. The terminal device is configured to: receive the configuration from the base station; receive the first indication from the base station; assign the first subset of power control parameters and the second subset of power control parameters to the physical uplink control channel resource; and transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

According to another aspect, there is provided a system comprising at least a base station and a terminal device. The base station comprises means for: transmitting a configuration to the terminal device, wherein the configuration comprises at least a first subset of power control parameters and a second subset of power control parameters; and transmitting, to the terminal device, a first indication for using a physical uplink control channel resource associated with the first subset of power control parameters and the second subset of power control parameters. The terminal device comprises means for: receiving the configuration from the base station; receiving the first indication from the base station; assigning the first subset of power control parameters and the second subset of power control parameters to the physical uplink control channel resource; and transmitting or repeating uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIGS. 2-5 illustrate flow charts according to some exemplary embodiments;

FIG. 6 illustrates a signalling diagram according to an exemplary embodiment;

FIGS. 7-8 illustrate flow charts according to some exemplary embodiments;

FIGS. 9-10 illustrate apparatuses according to exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

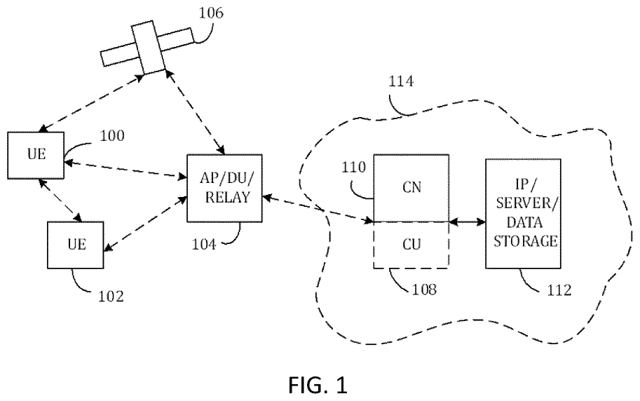

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g) NodeB) 104 providing the cell. The physical link from a user device to a (e/g) NodeB may be called uplink or reverse link and the physical link from the (e/g) NodeB to the user device may be called downlink or forward link. It should be appreciated that (e/g) NodeBs or their functionalities may be implemented by using any node, host, server or access point etc. entity suitable for such a usage.

A communication system may comprise more than one (e/g) NodeB, in which case the (e/g) NodeBs may also be configured to communicate with one another over links, wired or wireless, designed for the purpose. These links may be used for signaling purposes. The (e/g) NodeB may be a computing device configured to control the radio resources of communication system it is coupled to. The NodeB may also be referred to as a base station, an access point or any other type of interfacing device including a relay station capable of operating in a wireless environment. The (e/g) NodeB may include or be coupled to transceivers. From the transceivers of the (e/g) NodeB, a connection may be provided to an antenna unit that establishes bi-directional radio links to user devices. The antenna unit may comprise a plurality of antennas or antenna elements. The (e/g) NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It may also be possible that node operations will be distributed among a plurality of servers, nodes or hosts. Application of cloudRAN architecture may enable RAN real time functions being carried out at the RAN side (in a distributed unit, DU 104) and non-real time functions being carried out in a centralized manner (in a central unit, CU 108).

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may also comprise other apparatuses, such as physical layer relay nodes or other network elements, etc. At least one of the (e/g) NodeBs or may be a Home (e/g) nodeB. Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. In multilayer networks, one access node may provide one kind of a cell or cells, and thus a plurality of (e/g) NodeBs may be needed to provide such a network structure.

For fulfilling the need for improving the deployment and performance of communication systems, the concept of “plug-and-play” (e/g) NodeBs may be introduced. A network which may be able to use “plug-and-play” (e/g) Node Bs, may include, in addition to Home(e/g) NodeBs (H (e/g) nodeBs), a home node B gateway, or HNB-GW (not shown in FIG. 1). A HNB Gateway (HNB-GW), which may be installed within an operator's network, may aggregate traffic from a large number of HNBs back to a core network.

In wireless communication systems, uplink power control may be used to determine the transmit power of a UE for example for a physical uplink control channel (PUCCH) and a physical uplink shared channel (PUSCH). There are two types of power control loops, i.e. open-loop power control and closed-loop power control.

PUCCH is an uplink physical channel that carries uplink control information (UCI), whereas downlink control information (DCI) is carried by the physical downlink control channel (PDCCH). There are various parameters to define a specific PUCCH. The set of parameters for at least partly defining a specific PUCCH is called a PUCCH resource.

Based on the current specifications, PUCCH resource determination for a given UCI transmission on PUCCH may depend on at least one of the following: the PUCCH resource index (PRI) in DCI, the UCI payload size, the first control channel element (CCE) index of the PDCCH carrying the DCI, the total number of CCEs in the control resource set (CORESET) on which the PDCCH carrying the DCI has been transmitted, and/or a UCI configuration, such as a scheduling request (SR) configuration, a channel state information (CSI) configuration, or a semi-persistent scheduling (SPS) hybrid automatic repeat request acknowledgement (HARQ-ACK) configuration.

For example, a UE may determine the PUCCH resource for a given UCI transmission on PUCCH by using a HARQ-ACK corresponding to a PDCCH, wherein PUCCH resource determination is based on PRI in DCI and UCI payload size.

As another example, for SR, CSI and/or HARQ-ACK without a corresponding PDCCH, i.e. HARQ-ACK for SPS physical downlink shared channel (PDSCH), the UE may determine the PUCCH resource from the corresponding UCI configuration, wherein the selected PUCCH resource may depend on the UCI payload size.

The formula used to determine the PUCCH transmission power may depend on several parameters such as: P_{0_UE_PUCCH} which may be provided for example by p0-PUCCH-Value (which may also be denoted as p0 or P0), pathlossReferenceRS (i.e. pathloss reference reference-signal) used to determine pathloss estimate, closed-loop (or PUCCH power control adjustment state) index, and transmit power control (TPC) command value.

Based on the current specifications, for determining power control parameters for example in frequency range 1 (FR1), i.e. frequency bands below 6 GHz, when the UE is not provided PUCCH spatial relation information, the UE may obtain the value of the parameter p0, the pathloss value, and the closed-loop index based on pre-defined rules.

As an example of a pre-defined rule, if the UE is not provided a PUCCH-SpatialRelationInfo parameter, the UE may obtain the value of the p0-PUCCH-Value parameter from the p0-PUCCH parameter with a p0-PUCCH-Id parameter value equal to the minimum p0-PUCCH-Id value in p0-Set.

As another example of a pre-defined rule, if the UE is provided a pathlossReferenceRS parameter and is not provided a PUCCH-SpatialRelationInfo parameter, the UE may obtain the referenceSignal parameter value in PUCCH-PathlossReferenceRS from the PUCCH-PathlossReferenceRS-Id with index 0 in PUCCH-PathlossReferenceRS, where the reference signal (RS) resource is either on the primary cell, or, if provided, on a serving cell indicated by a value of pathlossReferenceLinking.

As another example of a pre-defined rule, the closed-loop index may be set to 0, if the UE is not provided PUCCH-SpatialRelationInfo.

In some multi-TRP PUCCH scheme(s), the substantially same PUCCH may be transmitted/repeated in a time-division-multiplexed (TDM) manner using two different uplink beams (or equivalently, spatial relation infos, or uplink transmission configuration indicator (TCI) states) towards different transmission reception points (TRP). A base station such as a gNB is an example of a TRP. Examples of multi-TRP PUCCH repetition/transmission schemes may comprise: the inter-slot repetition scheme, under which one PUCCH resource carries UCI, and another one or more PUCCH resources or the substantially same PUCCH resource in another one or more slots carries a repetition of the UCI; the intra-slot repetition scheme, under which one PUCCH resource carries UCI, and another one or more PUCCH resources or the substantially same PUCCH resource in another one or more sub-slots carries a repetition of the UCI; and the intra-slot beam hopping scheme, under which UCI is transmitted in one PUCCH resource in which different sets of symbols have different beams.

A single PUCCH resource may be used for the multi-TRP PUCCH repetition/transmission schemes. This at least implies that a single PUCCH resource can be used for TDMed repetitions transmitted using different uplink beams and/or towards different TRPs.

The determination of power control parameters described above can be used for example in FR1, since there may be no spatial relation information provided or configured for PUCCH resources in the FR1 frequency range. In addition, it should be noted that the above operation is conceived for the case with a single TRP, and it may suffer from limited flexibility. In other words, the above operation is not suitable for multi-TRP PUCCH schemes.

Some exemplary embodiments enable separate power control for multiple different TRPs for multi-TRP PUCCH repetition schemes for example in FR1. This may enable performing power control separately for PUCCH repetitions towards different TRPs, which may be beneficial as the characteristics of a link may substantially differ from one TRP to another.

In some exemplary embodiments, a PUCCH resource is linked or tied to two subsets of power control parameters, wherein the linkage is configured or dynamically indicated to the UE. A subset of power control parameters may comprise, for example, at least one of the following: a p0 value index, a pathloss reference RS index, and/or a closed-loop index. In other words, a subset of power control parameters may comprise open-loop power control parameters and/or closed-loop power control parameters. The UE may be configured to apply a given subset of power control parameters on a slot basis/level, a PUCCH repetition/transmission basis/level, or a PUCCH hop basis/level, or a number symbols basis.

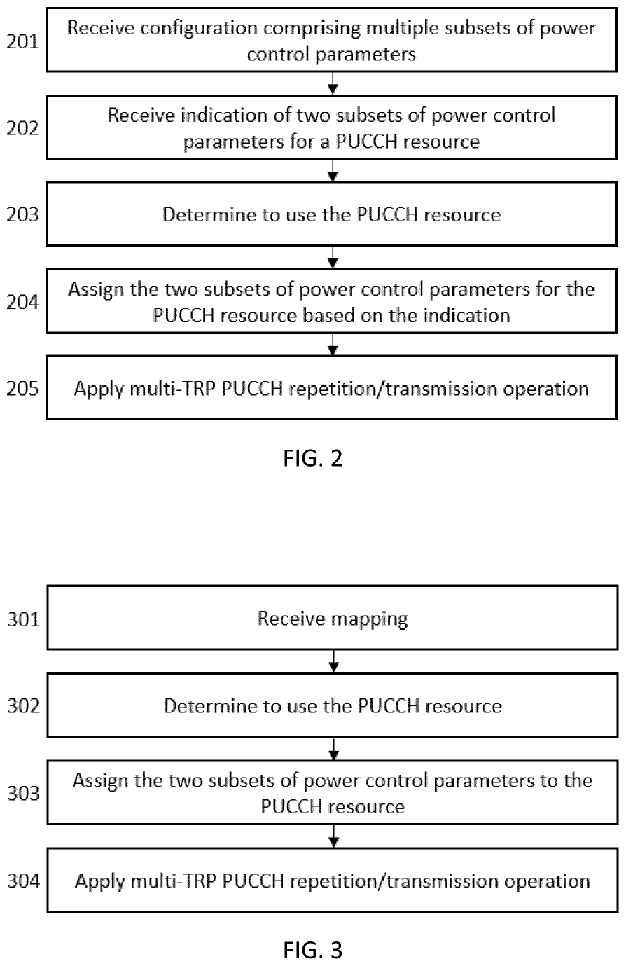

FIG. 2 illustrates a flow chart according to an exemplary embodiment. The functions illustrated in FIG. 2 may be performed by an apparatus such as a UE. A UE may also be referred to as a terminal device herein.

Referring to FIG. 2, a configuration is received 201 from a base station via radio resource control (RRC), wherein the configuration comprises a list or set comprising multiple subsets of power control parameters. The subsets of power control parameters may be indexed, for example. The set/list of multiple subsets of power control parameters may be configured to be specific for a given PUCCH resource, or it may be common for some or all of the configured PUCCH resources.

An indication is received 202 from the base station for example via a medium access control control element (MAC CE) or via DCI, wherein the indication indicates two subsets of power control parameters for a PUCCH resource from the multiple subsets of power control parameters. For example, the indication may comprise the PUCCH resource index and the indexes of the two corresponding subsets of power control parameters.

The indication via MAC CE for the PUCCH resource may be done for example by having one field for the PUCCH resource index, wherein this field is associated with two corresponding fields comprising the indexes of the corresponding two subsets of power control parameters. Alternatively, the indication for the PUCCH resource may be given by having a field for the PUCCH resource index, wherein this field is associated with a single field corresponding to one of the two subsets of power control parameters, in which case the PUCCH resource index may be indicated twice in one MAC CE in order to indicate the two subsets of power control parameters for the PUCCH resource. In a variant for this latter alternative, two MAC CEs which are sent separately may be used, wherein both MAC CEs comprise one field for the PUCCH resource index, and this field is associated with a single field corresponding to one of the two subsets of power control parameters.

The indication may also be used to at least partly indicate that the UE is expected to perform multi-TRP PUCCH repetition/transmission instead of single TRP PUCCH repetition/transmission. For example, if the UE receives a MAC CE indication of the two subsets of power control parameters, and the UE is indicated via DCI of a PUCCH resource associated with the two subsets of power control parameters, the UE is thus also indicated to perform multi-TRP PUCCH repetition/transmission. If no such indication is received, the UE may perform single TRP PUCCH repetition/transmission.

The PUCCH resource is then determined 203 to be used for example based on the PRI field in DCI and the UCI payload size. The two subsets of power control parameters are assigned 204, or mapped, to the PUCCH resource based on the indication.

Multi-TRP PUCCH repetition/transmission operation is then applied 205, while the PUCCH resource is assigned, or mapped, to the two subsets of power control parameters. For instance, if multi-TRP PUCCH inter-slot or intra-slot repetition scheme is used, the UE uses the first subset of power control parameters to determine, at least partly, the PUCCH power for PUCCH repetitions towards one TRP and the second subset of power control parameters to determine, at least partly, the PUCCH power for PUCCH repetitions towards another TRP. The UE may determine that multi-TRP PUCCH repetition/transmission is expected, if a mapping of two subsets of power control parameters to the PUCCH resource is indicated in the received configuration.

The above procedure may be applicable, for example, when spatial relation information, i.e. uplink beams or uplink TCI states, for PUCCH is not indicated/configured.

In some exemplary embodiments, the gNB may configure the UE with a mapping pattern in order for the UE to know how to map the two subsets of power control parameters to the PUCCH transmissions/repetitions. FIG. 3 illustrates a flow chart according to an exemplary embodiment, wherein the UE is configured with a mapping pattern for the two subsets of power control parameters. The functions illustrated in FIG. 3 may be performed by an apparatus such as a UE.

Referring to FIG. 3, a mapping is received 301 from a base station via RRC, wherein the mapping indicates using a first subset of power control parameters for transmitting or repeating to a first TRP, and using a second subset of power control parameters for transmitting or repeating to a second TRP. The mapping may be received in the configuration comprising the first and second subset of power control parameters, or the mapping may be received in a separate message. A PUCCH resource associated with the first and second subset of power control parameters is then determined 302 to be used for example based on the PRI field in DCI and the UCI payload size. The two subsets of power control parameters are assigned 303, or mapped, to the PUCCH resource. Multi-TRP PUCCH repetition/transmission operation is then applied 304, while the PUCCH resource is assigned, or mapped, to the two subsets of power control parameters. The first subset of power control parameters is used for transmitting or repeating to the first TRP, and the second subset of power control parameters is used for transmitting or repeating to the second TRP.

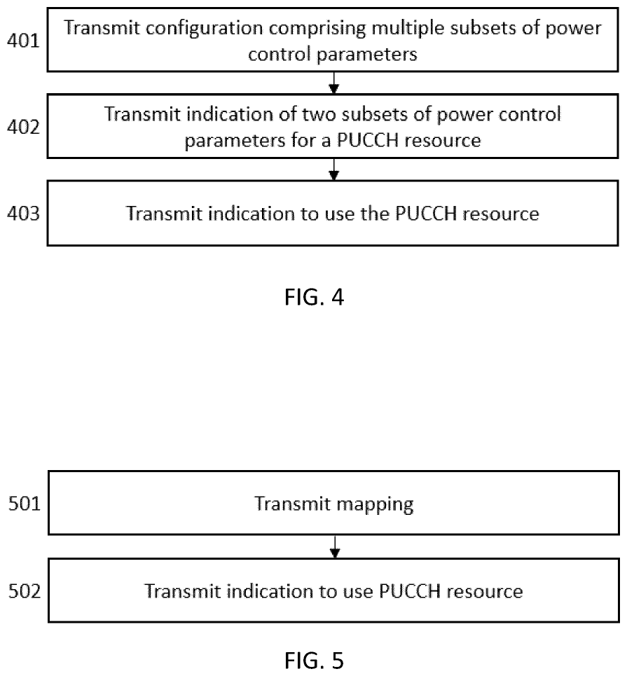

FIG. 4 illustrates a flow chart according to an exemplary embodiment. The functions illustrated in FIG. 4 may be performed by a base station such as a gNB. FIG. 4 illustrates an exemplary embodiment corresponding with FIG. 2, but FIG. 4 is from the perspective of the base station, whereas FIG. 2 is from the perspective of the UE.

Referring to FIG. 4, a configuration is transmitted 401 to a UE via RRC, wherein the configuration comprises a list or set comprising multiple subsets of power control parameters. The subsets of power control parameters may be indexed, for example. The set/list of multiple subsets of power control parameters may be configured to be specific for a given PUCCH resource, or it may be common for some or all of the configured PUCCH resources.

A first indication is transmitted 402 to the UE for example via MAC CE or via DCI, wherein the first indication indicates two subsets of power control parameters for a PUCCH resource from the multiple subsets of power control parameters. For example, the first indication may comprise the PUCCH resource index and the indexes of the two corresponding subsets of power control parameters.

A second indication is transmitted 403 to the UE, wherein the second indication indicates the UE to use the PUCCH resource, for example based on the PRI field in DCI and the UCI payload size.

FIG. 5 illustrates a flow chart according to an exemplary embodiment. The functions illustrated in FIG. 5 may be performed by a base station such as a gNB. FIG. 5 illustrates an exemplary embodiment corresponding with FIG. 3, but FIG. 5 is from the perspective of the base station, whereas FIG. 3 is from the perspective of the UE.

Referring to FIG. 5, a mapping is transmitted 501 to a UE via RRC, wherein the mapping indicates using a first subset of power control parameters for transmitting or repeating to a first TRP, and using a second subset of power control parameters for transmitting or repeating to a second TRP. The mapping may be transmitted in the configuration comprising the first and second subset of power control parameters, or the mapping may be transmitted in a separate message. An indication is transmitted 502 to the UE, wherein the indication indicates the UE to use a PUCCH resource associated with the first and second subset of power control parameters, for example based on the PRI field in DCI and the UCI payload size.

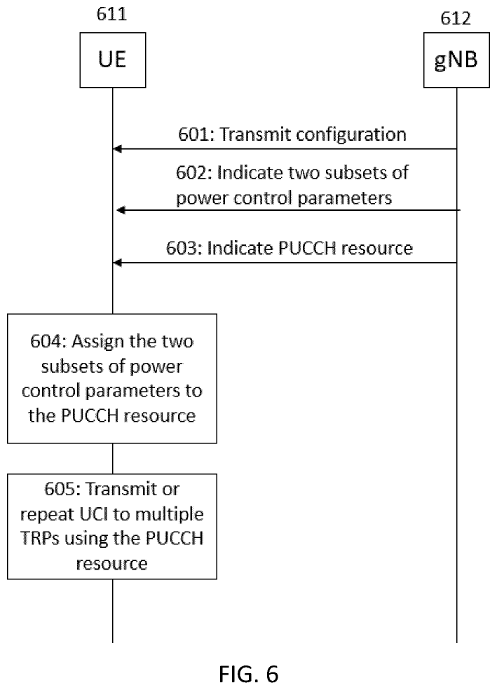

FIG. 6 illustrates a signaling diagram according to an exemplary embodiment (corresponding with FIGS. 2 and 4). Referring to FIG. 6, a base station 612 such as a gNB transmits 601 a configuration to a terminal device 611, wherein the configuration comprises at least a first subset of power control parameters and a second subset of power control parameters. The base station transmits 602 a first indication to the UE for example via MAC CE or via DCI, wherein the first indication indicates the two subsets of power control parameters for a PUCCH resource. For example, the first indication may comprise the PUCCH resource index and the indexes of the two corresponding subsets of power control parameters. The base station transmits 603 a second indication to the UE, wherein the second indication indicates the UE to use the PUCCH resource associated with the first and second subset of power control parameters, for example based on the PRI field in DCI and the UCI payload size. The terminal device assigns 604 the first subset of power control parameters and the second subset of power control parameters to the PUCCH resource. The terminal device transmits 605, or repeats, UCI at least to a first TRP and to a second TRP using the PUCCH resource, wherein the first subset of power control parameters is used for transmitting or repeating to the first TRP, and the second subset of power control parameters is used for transmitting or repeating to the second TRP.

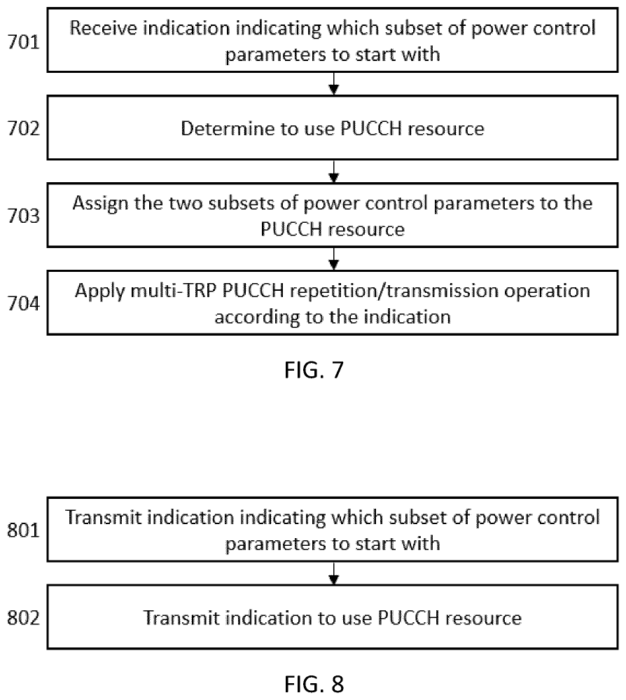

FIG. 7 illustrates a flow chart according to another exemplary embodiment. In this exemplary embodiment, in order to know which subset of power control parameters to start with, the UE may be configured with a pre-defined rule, for example to start with the first subset of power control parameters. Alternatively, the UE may be dynamically indicated, for example with 1-bit information via MAC CE or DCI, on whether to start with the first subset or the second subset.

Referring to FIG. 7, an indication, or rule, is received 701 from a base station to indicate using the first subset of power control parameters for transmitting or repeating to a first TRP before using the second subset of power control parameters for transmitting or repeating to a second TRP. A PUCCH resource associated with the first and second subset of power control parameters is then determined 702 to be used for example based on the PRI field in DCI and the UCI payload size. The two subsets of power control parameters are assigned 703, or mapped, to the PUCCH resource. Multi-TRP PUCCH repetition/transmission operation is then applied 704 according to the received indication or rule, while the PUCCH resource is assigned, or mapped, to the two subsets of power control parameters. In other words, the first subset of power control parameters is used for transmitting or repeating to the first TRP before using the second subset of power control parameters for transmitting or repeating to the second TRP.

FIG. 8 illustrates a flow chart according to an exemplary embodiment corresponding with FIG. 7. FIG. 8 is from the perspective of the base station, whereas FIG. 7 is from the perspective of the UE.

Referring to FIG. 8, a first indication, or rule, is transmitted 801 to a terminal device to indicate using the first subset of power control parameters for transmitting or repeating to a first TRP before using the second subset of power control parameters for transmitting or repeating to a second TRP. A second indication is transmitted 802 to the UE, wherein the second indication indicates the UE to use a PUCCH resource associated with the first and second subset of power control parameters, for example based on the PRI field in DCI and the UCI payload size.

The functions and/or blocks described above by means of FIGS. 2-8 are in no absolute chronological order, and some of them may be performed simultaneously or in an order differing from the described one. Other functions and/or blocks may also be executed between them or within them.

A technical advantage provided by some exemplary embodiments is that they enable separate power control for multiple different TRPs for multi-TRP PUCCH repetition schemes for example in FR1. Some exemplary embodiments may provide flexible and/or dynamic operation in configuring and indicating the separate power control parameters. Such operation may be beneficial, since the characteristics of a link may substantially vary from one TRP to another for a given UE, and thus different power control parameters can be adjusted separately for the different links.

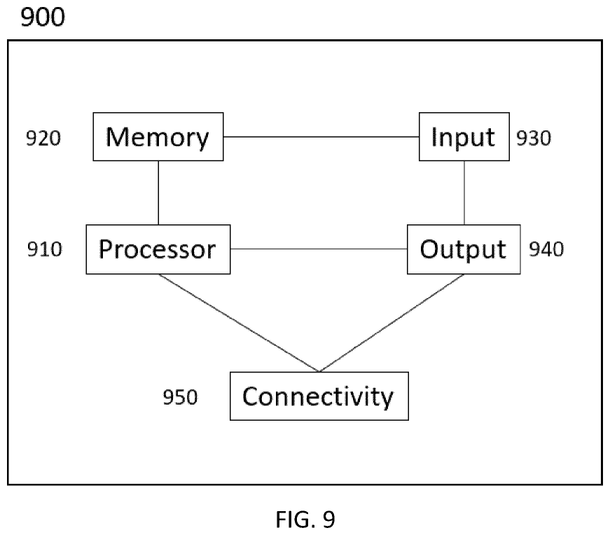

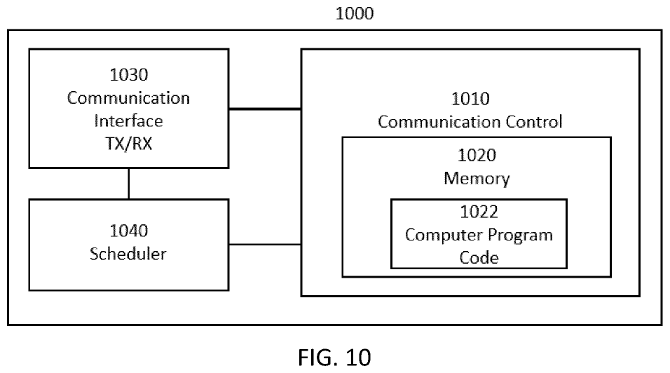

FIG. 9 illustrates an apparatus 900, which may be an apparatus such as, or comprised in, a terminal device, according to an exemplary embodiment. The apparatus 900 comprises a processor 910. The processor 910 interprets computer program instructions and processes data. The processor 910 may comprise one or more programmable processors. The processor 910 may comprise programmable hardware with embedded firmware and may, alternatively or additionally, comprise one or more application specific integrated circuits, ASICs.

The processor 910 is coupled to a memory 920. The processor is configured to read and write data to and from the memory 920. The memory 920 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 920 stores computer readable instructions that are executed by the processor 910. For example, non-volatile memory stores the computer readable instructions and the processor 910 executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 900 may further comprise, or be connected to, an input unit 930. The input unit 930 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application specific integrated circuit (ASIC). The connectivity unit 950 may comprise one or more components such as a power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 900 may further comprise various components not illustrated in FIG. 9. The various components may be hardware components and/or software components.

The apparatus 1000 of FIG. 10 illustrates an exemplary embodiment of an apparatus such as, or comprised in, a base station such as a gNB. The apparatus may comprise, for example, a circuitry or a chipset applicable to a base station to realize some of the described exemplary embodiments. The apparatus 1000 may be an electronic device comprising one or more electronic circuitries. The apparatus 1000 may comprise a communication control circuitry 1010 such as at least one processor, and at least one memory 1020 including a computer program code (software) 1022 wherein the at least one memory and the computer program code (software) 1022 are configured, with the at least one processor, to cause the apparatus 1000 to carry out some of the exemplary embodiments described above.

The memory 1020 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store a current neighbour cell list, and, in some exemplary embodiments, structures of the frames used in the detected neighbour cells.

The apparatus 1000 may further comprise a communication interface 1030 comprising hardware and/or software for realizing communication connectivity according to one or more communication protocols. The communication interface 1030 may provide the apparatus with radio communication capabilities to communicate in the cellular communication system. The communication interface may, for example, provide a radio interface to terminal devices. The apparatus 1000 may further comprise another interface towards a core network such as the network coordinator apparatus and/or to the access nodes of the cellular communication system. The apparatus 1000 may further comprise a scheduler 1040 that is configured to allocate resources.

As used in this application, the term “circuitry” may refer to one or more or all of the following:
a. hardware-only circuit implementations (such as implementations in only analog and/or digital circuitry) and
b. combinations of hardware circuits and software, such as (as applicable):
   i. a combination of analog and/or digital hardware circuit(s) with software/firmware and
   ii. any portions of hardware processor(s) with software (including digital signal processor(s)), software, and memory(ies) that work together to cause an apparatus, such as a mobile phone, to perform various functions) and
c. hardware circuit(s) and or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

### LIST OF ABBREVIATIONS

4G: fourth generation
5G: fifth generation
ADC: analog-to-digital converter
ASIC: application-specific integrated circuit
CCE: control channel element
CN: core network
CORESET: control resource set
CPS: cyber-physical system
CSI: channel state information
CU: central unit
DAC: digital-to-analog converter
DCI: downlink control information
DFE: digital front end
DSP: digital signal processor
DSPD: digital signal processing device
DU: distributed unit
FPGA: field programmable gate array
FR1: frequency range 1
GEO: geostationary earth orbit
gNB: next generation nodeB
GPU: graphics processing unit
HARQ-ACK: hybrid automatic repeat request acknowledgement
HNB-GW: home node B gateway
IIoT: industrial internet of things
IMS: internet protocol multimedia subsystem
IoT: internet of things
LCD: liquid crystal display
LCoS: liquid crystal on silicon
LED: light emitting diode
LEO: low earth orbit
LTE: long term evolution
LTE-A: long term evolution advanced
M2M: machine-to-machine
MAC CE: medium access control control element
MANET: mobile ad-hod network
MEC: multi-access edge computing
MIMO: multiple input and multiple output
MME: mobility management entity
mMTC: massive machine-type communications
NGC: next generation core
NR: new radio
NFV: network function virtualization
PCS: personal communications services
PDA: personal digital assistant
PDCCH: physical downlink control channel
PDSCH: physical downlink shared channel
P-GW: packet data network gateway
PLD: programmable logic device
PRI: PUCCH resource index
PUCCH: physical uplink control channel
PUSCH: physical uplink shared channel
RAN: radio access network
RAT: radio access technology
RI: radio interface
RRC: radio resource control
RS: reference signal
SDN: software defined networking
S-GW: serving gateway
SIM: subscriber identification module
SPS: semi-persistent scheduling
SR: scheduling request
TCI: transmission configuration indicator
TDM: time-division multiplexing
TPC: transmit power control
TRP: transmission reception point
UCI: uplink control information
UE: user equipment
UMTS: universal mobile telecommunications system
UTRAN: UMTS radio access network
UWB: ultra-wideband
WCDMA: wideband code division multiple access
WiMAX: worldwide interoperability for microwave access
WLAN: wireless local area network

1-18. (canceled)

19. An apparatus comprising:
at least one processor; and
at least one memory including computer program code,
the at least one memory and the computer program code configured to, with the at least one processor, cause the apparatus to:
receive a configuration from a base station, wherein the configuration comprises at least a first subset of power control parameters and a second subset of power control parameters;
assign the first subset of power control parameters and the second subset of power control parameters to a physical uplink control channel resource;
transmit or repeat uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.

20. The apparatus of claim 19, wherein the at least one memory and the computer program code are configured to, with the at least one processor, cause the apparatus to:
receive, from the base station, a first indication for assigning at least the first subset of power control parameters to the physical uplink control channel resource;
wherein the first subset of power control parameters and the second subset of power control parameters are assigned to the physical uplink control channel resource based at least partly on the received first indication.

21. The apparatus of claim 20, wherein the first indication comprises a first index associated with the physical uplink control channel resource, a second index associated with the first subset of power control parameters, and a third index associated with the second subset of power control parameters.

22. The apparatus of claim 20, wherein the at least one memory and the computer program code are configured to, with the at least one processor, cause the apparatus to:
receive a second indication from the base station, wherein the second indication comprises a fourth index associated with the physical uplink control channel resource, and a fifth index associated with the second subset of power control parameters;
wherein the first indication comprises the fourth index associated with the physical uplink control channel resource, and a sixth index associated with the first subset of power control parameters.

23. The apparatus of claim 19, wherein the at least one memory and the computer program code are configured to, with the at least one processor, cause the apparatus to:
receive, from the base station, a mapping for the first subset of power control parameters and the second subset of power control parameters, wherein the mapping indicates using the first subset of power control parameters for transmitting or repeating to the first transmission reception point, and using the second subset of power control parameters for transmitting or repeating to the second transmission reception point.

24. The apparatus of claim 19, wherein the at least one memory and the computer program code are configured to, with the at least one processor, cause the apparatus to:
receive, from the base station, a third indication for using the first subset of power control parameters for transmitting or repeating to the first transmission reception point before using the second subset of power control parameters for transmitting or repeating to the second transmission reception point.

25. The apparatus of claim 19, wherein the uplink control information is transmitted or repeated by applying multiple transmission reception point physical uplink control channel transmission or repetition operation.

26. The apparatus of claim 19, wherein the apparatus is comprised in a terminal device.

27. An apparatus comprising:
at least one processor; and
at least one memory including computer program code,
the at least one memory and the computer program code configured to, with the at least one processor, cause the apparatus to:
transmit a configuration to a terminal device, wherein the configuration comprises at least a first subset of power control parameters and a second subset of power control parameters;
transmit, to the terminal device, a first indication for using a physical uplink control channel resource associated with the first subset of power control parameters and the second subset of power control parameters.

28. The apparatus of claim 27, wherein the at least one memory and the computer program code are configured to, with the at least one processor, cause the apparatus to:
transmit, to the terminal device, a second indication for assigning the first subset of power control parameters and/or the second subset of power control parameters to the physical uplink control channel resource.

29. The apparatus of claim 27, wherein the at least one memory and the computer program code are configured to, with the at least one processor, cause the apparatus to:
transmit, to the terminal device, a mapping for the first subset of power control parameters and the second subset of power control parameters, wherein the mapping indicates using the first subset of power control parameters for transmitting or repeating to a first transmission reception point, and using the second subset of power control parameters for transmitting or repeating to a second transmission reception point.

30. The apparatus of claim 27, wherein the at least one memory and the computer program code are configured to, with the at least one processor, cause the apparatus to:
transmit, to the terminal device, a third indication for using the first subset of power control parameters for transmitting or repeating before using the second subset of power control parameters for transmitting or repeating.

31. The apparatus of claim 27, wherein the uplink control information is transmitted or repeated by applying multiple transmission reception point physical uplink control channel transmission or repetition operation.

32. A method, comprising:
receiving a configuration from a base station, wherein the configuration comprises at least a first subset of power control parameters and a second subset of power control parameters; assigning the first subset of power control parameters and the second subset of power control parameters to a physical uplink control channel resource;
transmitting or repeating uplink control information at least to a first transmission reception point and to a second transmission reception point using the physical uplink control channel resource, wherein the first subset of power control parameters is used for transmitting or repeating to the first transmission reception point, and the second subset of power control parameters is used for transmitting or repeating to the second transmission reception point.
